(19) United States
(12) Patent Application Publication
(10) Pub. No.: US 2009/0252366 A1
(43) Pub. Date: Oct. 8, 2009

(54) DECORATIVE AND REMOVABLE EARBUD COVER

(76) Inventor: Brian Johnson, San Diego, CA (US)

Correspondence Address: ERIC HANSCOM, 7395 PORTAGE WAY, CARLSBAD, CA, 92011, US

(21) Appl. No.: 12/099,096

(22) Filed: Apr. 7, 2008

(51) Int. Cl. H04R 5/033

(52) U.S. Cl. 381/380

(57) ABSTRACT

A decorative and removable earbud cover is disclosed that can attach to earbuds, earpieces, headphones, or the like. The earbud cover includes two major components: an attachment portion and a decorative portion. The attachment portion snaps over a cylindrical earbud portion of a user's earbud such that the attachment portion grips the earbud and is prevented from falling off. A particularly preferred embodiment of the invention has the attachment portion with a tapered end which mates neatly with the contours of an iPod earbud.

### CROSS REFERENCE TO RELATED APPLICATIONS

None.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of headphones, and more specifically toward a decorative and removable earbud cover that can attach to headphones. The earbud cover includes two major components: an attachment portion and a decorative portion. The attachment portion snaps over a cylindrical earbud portion of a user's earbud such that the attachment portion grips the earbud and is prevented from falling off. A particularly preferred embodiment of the invention has the attachment portion with a tapered end which mates neatly with the contours of an iPod earbud.

Devices through which a user of a sound-producing device can listen without disturbing others or maintaining one's privacy have been known in the art for many years. Headphones were the first such devices known, and date back to the 1800's and were used frequently during the production of early radio work. Earbuds are a more recent develop, but function according to the same general principles: a transducer is placed next to the ear, when the transducer receives an electrical signal from a radio or other sound-producing device, it converts the electrical signal into sound waves that are made audible and directed into the ear canal by a speaker. Despite concerns over their effect on hearing and the limitations of some earbuds to effectively process a wide range of sounds and tones, earbuds have rapidly become the most popular form of listening devices and are frequently bundled with various sound-producing devices such as radios, stereos, and, particularly, portable music playing devices such as iPod's, where the earbuds' light weight and ease of portability make them ideal for this type of device. As such, earbuds are used extensively by a young demographic that is also quite influenced by fashion.

While earbuds have proven to be a long-lasting and popular addition to the pop culture, they are rather plain in appearance. Thus, it is desirable to enhance them with some sort of decorative embellishments such that they do not appear as a mere unadorned earpiece.

The prior art has several examples of attempts to resolve this problem. For example, there are jewelry-encrusted earpieces that can be bought. However, these earpieces are expensive, and the jewelry with which they are covered cannot be removed and exchanged for other jewelry.

Thus there has existed a long-felt need for a decorative covering for an earbud which can be easily attached and removed, and can be produced for a reasonable price.

The current invention provides just such a solution by having an earbud cover which can easily snap on and off the cylindrical stem of an earbud, and contains a decorative portion that covers the stem, the speaker of the earbud, or both.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims. The accompanying drawings, which are incorporated in and constitute part of this specification, illustrate embodiments of the invention and, together with the description, serve to explain the principles of the invention.

### SUMMARY OF THE INVENTION

A preferred embodiment of the invention is designed to removably attach in a secure manner to the earbud of an Apple iPod. The earbud cover has two basic parts: an attachment portion and a decorative portion. The attachment portion comprises a semi-circular, cylindrically shaped sleeve which snaps over a cylindrical earbud portion. The attachment portion may be constructed from a variety of materials, including plastic, and must be thick enough and rigid enough such that the sides grip the earbud and prevent the invention from falling off. A particularly preferred embodiment of the invention has the attachment portion with a tapered end which mates neatly with the contours of an iPod earbud, where the top member has a length of 20 mm and the side members have a length of 16 mm along the side furthest from the top member.

A preferred embodiment calls for a six-beveled unit with an approximate inner diameter of 4 mm and a length of 20 mm. Another preferred embodiment has a flat upper surface with a length of 10 mm, with curved sides and an approximate inner diameter of 4 mm. As the inner surface of the invention is not a complete cylinder, but rather has an opening at the bottom which allows the invention to be snapped over the stem, where there is approximately a 90 degree opening between the two sides. The measurement of the inner surface is important to the invention. A preferred embodiment has the inner surface with a circumferential length of 14 mm.

On the upper surface of the attachment portion is the decorative portion, where a variety of jewelry, precious and semi-precious gems, stones, and earrings can be attached. The ease with which the invention can be attached and removed from an earpiece allows a user of the invention to quickly and easily change their earpiece jewelry, or even trade different “looks” with their friends.

Earbud, as used previously and hereinafter, is intended to include any device that comprises small speakers used to produce sound that are inserted into or secured near a user's ear, such as headphones and earpieces. While the invention is particularly suited for covering the earbuds, or earpieces, of an Apple iPod, the design of the invention allows its use on any thin object.

It is a principal object of the invention to provide a means by which a user of a pair of earbuds can easily and quickly change the exterior appearance of the stem and/or back of the earbud.

It is another object of the invention to provide a variety of earbud covers such that a user of earbuds can change the decoration on the earbuds as is desired.

It is an additional object of the invention that the decorative covers can be manufactured for a relatively low price, thereby allowing a user of the invention to affordably purchase more than one such set of covers.

It is a further object of the invention that the decorative covers be removably attached to the stem section of an earbud with adequate security such that the decorative cover does not fall off during exerting activities such as dancing, running, etc.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

### BRIEF DESCRIPTION OF THE FIGURES

FIG. 1 is a front view of the invention, showing how the side members removably secure the invention to the stem of an earbud or other cylindrical object.

FIG. 2 is a side view of one embodiment of the invention where the decorative cover slides over the stem of the earbud but does not cover the speaker portion.

FIG. 3 is a side view of another embodiment of the invention where the decorative cover slides over the stem and speaker portion of the earbud.

FIG. 4 shows two preferred embodiments of the invention with different top surface configurations.

FIG. 5 shows several embodiments of the jewelry configurations that can be used to decorate the top surface.

### DETAILED DESCRIPTION OF THE FIGURES

Many aspects of the invention can be better understood with reference to the drawings below. The components in the drawings are not necessarily drawn to scale. Instead, emphasis is placed upon clearly illustrating the components of the present invention. Moreover, like reference numerals designate corresponding parts through the several views in the drawings.

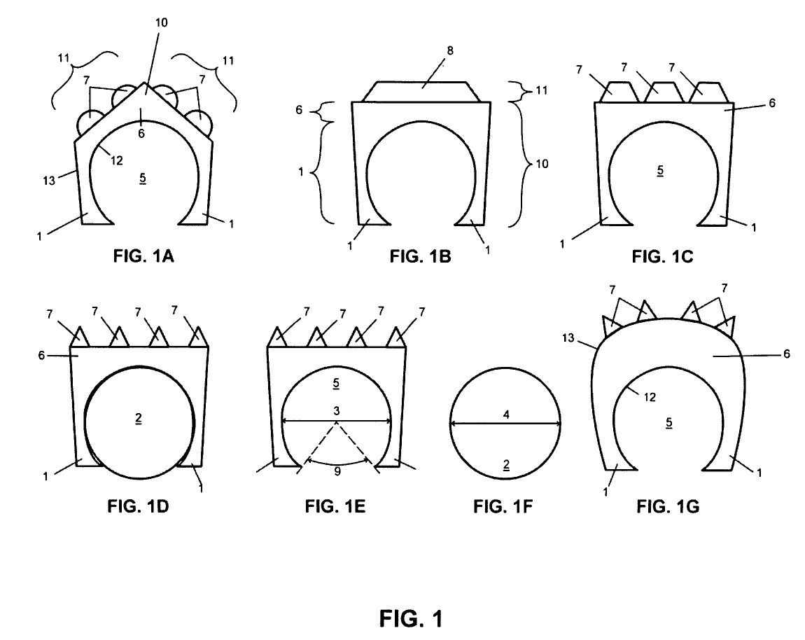

FIG. 1 is a front view of the invention. The invention has two basic parts: an attachment portion 10 and a decorative portion 11. The attachment portion includes a top member 6 and two side members 1. As seen in FIG. 1A, the two side members 1 are each attached to a side of the top member 6 thereby creating an outer surface 13 and an inner surface 12. The decorative portion 11 includes multiple decorative items 7 that are attached to the top member 6 of the attachment portion 10. A variety of decorative items can be used, such as gems, rhinestones, diamonds, colored glass, earrings, pendants, metal, plastics, or any other item that is commonly used in jewelry. In this figure, the attachment portion 10 is shown with four sides where the top member 6 is pointed in the middle. The shape and position of the side members 1 and the top member 6 create an inner cavity 5, where the inner cavity is bounded by the inner surface 12.

FIG. 1B shows an alternative embodiment of the invention where the top member 6 has a flat surface. The attachment portion 10 has two side members 1 and a top member 6 where the top member 6 has a flat surface. Attached to the top member 6 is a solitaire setting 8. As with multiple decorative items, the solitaire setting 8 can be one of a variety of decorative items, including gems, rhinestones, diamonds, colored glass, earrings, pendants, metal, plastics, or any other item that is commonly used in jewelry. FIG. 1C shows a similar iteration of the invention to FIG. 1B, but with multiple decorative items 7 attached to the top member 6.

FIGS. 1D, 1E, and 1F show how the side members 1 removably secure the invention to the stem 2 of an earbud or other cylindrical object. The stem 2 fills the inner cavity 5 of the attachment portion bounded by the two side members 1 and the top member 6. The invention is preferably manufactured such that the inner diameter 3 of the inner surface 12 which bounds the inner cavity 5 is slightly smaller than the outer diameter 4 of the earbud stem 2. Further, the angle of the angle of the opening 9 is preferably 90 degrees to allow the stem 2 of the earbud to be easily inserted and removed from the invention as well as secured to the invention. The decorative portion includes multiple decorative items 7 that are attached to the outer surface of the attachment portion, specifically to the flat area of the top member 6.

FIG. 1G shows yet another embodiment of the current invention. The attachment portion includes a top member 6 and two side members 1, where the outer surface 13 of the attachment portion is rounded such that there is not flat surface. Attached to the outer surface are multiple decorative items 7. Opposite of the outer surface 3 is the inner surface 12 that bounds the inner cavity 5.

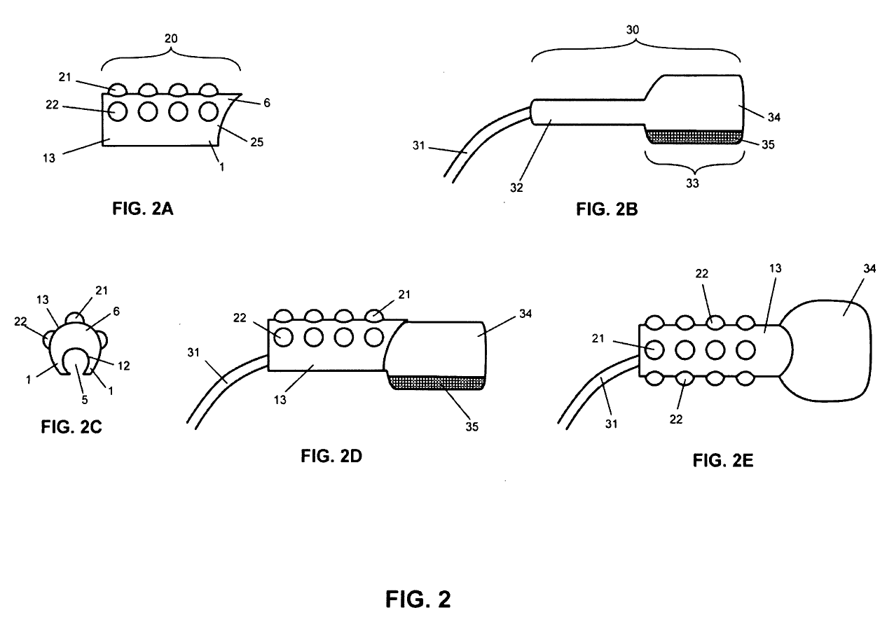

FIG. 2 is a side view of one embodiment of the invention where the decorative cover slides over the stem 32 of the earbud 30, but doesn't cover the speaker portion 33. The decorative cover, generally referred to by reference number 20, has a top member 6, two side members 1, top gems 21, and side gems 22. FIG. 2A shows the decorative cover with a facet edge 25, where the side of the side member 1 closest to the top member 6 is longer than the side of the side member 1 that is furthest away form the top member 6. FIG. 2C shows a back view of the decorative cover 20, showing the top member 6, two side members 1, top gems 21, side gems 22, outer surface 13, and inner surface 12. The shape of the decorative cover 20 forms an inner cavity 5.

The earbud, as shown in FIG. 2B and generally referred to by reference number 30, has an electrical cord 31 which feeds into a stem 32. The stem 32 serves as a rigid conduit for the electrical cord 31 to the speaker portion, generally referred to by reference number 33, where the electrical signals from the iPod or other electronic device are converted in the transducer 34 and released as sound waves from the speaker 35.

The decorative cover 20 is secured to the stem of the earbud 30 by placing the stem 32 into the inner cavity 5 of the decorative cover 20. As the decorative cover 20 is slid over the stem 32, the facet edge 25 of the decorative cover 20 is impeded by an angle on the transducer 34 that matches the angle of the facet edge 25, thereby stopping the progress of the decorative cover, as shown in FIGS. 2D and 2E. In this embodiment of the invention, the decorative cover in its final attached position covers the stem 32 of the earbud 30, but does not cover the speaker portion 33.

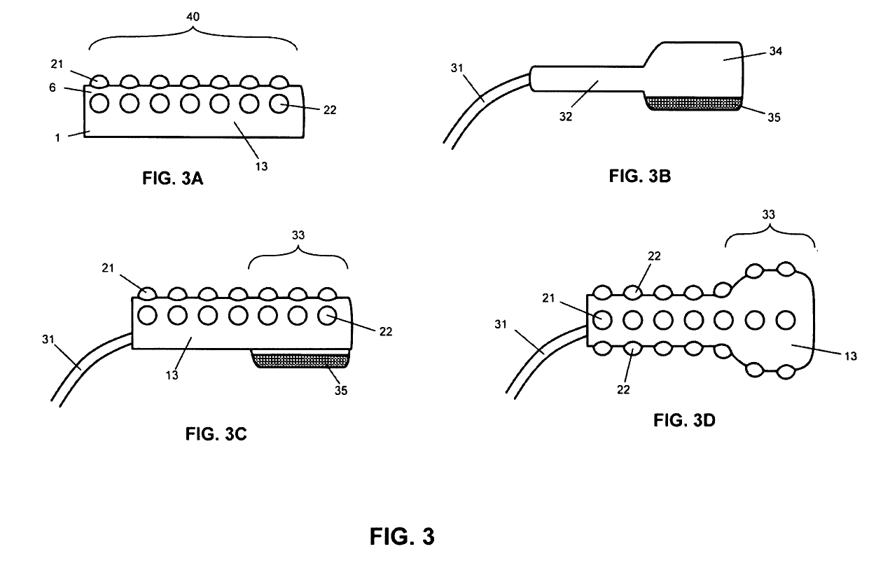

FIG. 3 is a side view of another embodiment of the invention where the decorative cover, generally referred to by reference number 40, slides over the stem 32 and speaker portion 33 of the earbud, leaving only the speaker 35 exposed from a side view. FIG. 3A shows just the decorative cover 40 itself, where the top member 6 and the side members 1 are approximately the same length. FIG. 3B is a side view of an earbud. As can be seen in FIGS. 3C and 3D, the decorative cover 40 covers both the stem 32 and speaker potion 33 of the earbud.

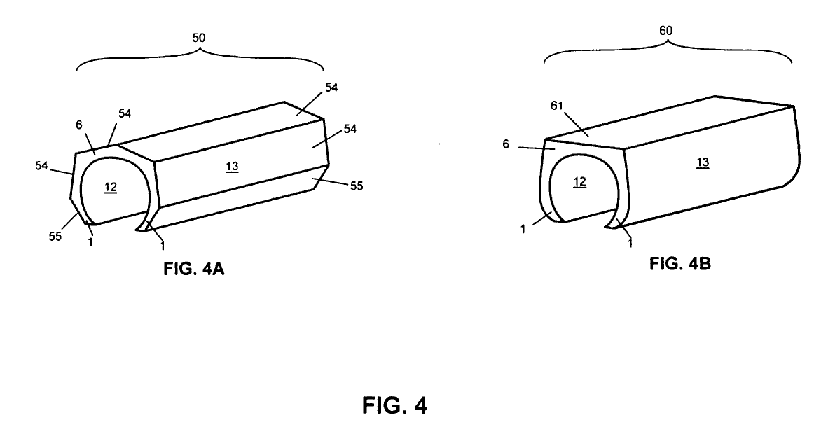

FIG. 4 shows two preferred embodiments of the invention with different top surface configurations. FIG. 4A shows a six-sided decorative cover 50 without the facet edge as shown in the embodiments of the invention described and illustrated specifically in FIG. 2. Instead, the six-sided decorative cover 50 has six sides which provide both the gripping sides of the attachment portion and an outer surface 13 comprised of several surfaces for the display of gems and other jewelry items on the decorative portion. The six-sided decorative cover has four wider sides 54 which are preferably 4 mm in width and form the four uppermost edges. There are also two thinner sides 55 which are preferably 2 mm in width and form the two lowermost edges. The preferred embodiment of this iteration of the invention has a length of 20 mm. The inner diameter of the inner cavity, bounded by the inner surface 12 of the six-sided decorative cover 50, is 4 mm. The circumferential length of the inner surface 12 of the decorative cover 50 is 14 mm. The four wider sides 54 have flat surfaces wide enough to serve as points of attachment for one or more decorative items, which are not shown in this figure.

FIG. 4B shows another preferred embodiment of the invention, generally referred to by reference number 60, with a single flat surface 61 that is flat or only slightly rounded, with a length of 20 mm and a width of 10 mm. The two side members 1 curve inward at their bottoms to form the gripping portion. The outer surface 13 of the decorative cover 60 is comprised of the single flat surface 61 and the outer surfaces of the side members 1. The inner diameter of the inner surface 12 of this embodiment is 4 mm, and the circumferential length of the inner surface is 14 mm. The flat upper surface 61 is flat enough and wide enough to serve as the base upon which a wide range of decorative items, including pendants and larger pieces of jewelry, can be attached.

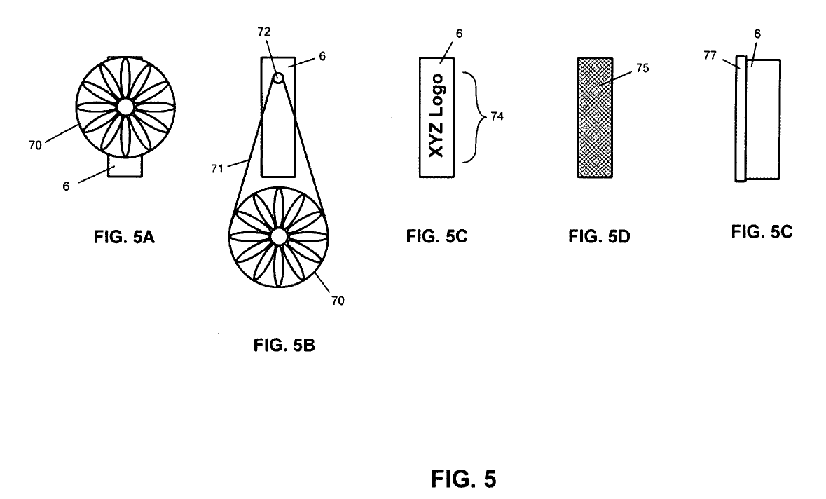

FIG. 5 shows several embodiments of the jewelry configurations that can be used to decorate the top surface. FIG. 5A shows a piece of jewelry 70 fixed to the top member 6. Such pieces of jewelry 70 can include large gems, the types of settings traditionally found on rings, solitaires, or any other larger piece of jewelry that cannot fit on the multi-sided embodiments of the invention. Another embodiment has a hanging piece of jewelry 70 attached to the top member 6 of the invention at a point of attachment 72 by a wire 71. Other means of attachment are contemplated by the inventor and fall within the scope of the current invention. It is envisioned that the attachment between the wire 71 and the top member 6 can be free swinging such that the jewelry 70 can swing back and forth as the user of the invention moves.

The invention also has considerable benefits to offer a prospective advertiser, as illustrated by FIG. 5C, which shows an advertising logo 74 emblazoned, engraved, or etched on the upper surface. It should be noted that combinations of advertising logos and jewelry are also possible and contemplated by the inventor as being part of his invention. A further innovation can be created by affixing a plate 77 to the top member 6 of a decorative cover. The plate can be made from a wide range of materials, including plastic and metal, and can have various coatings or finishes applied to the exterior of the plate. The plate can be engraved with the name of a famous person, musical group, product, country, or other person, item, or location, and, optionally, can have decorative gems affixed around the name.

A decorative cover with safety reflective tape 75 is another embodiment of the invention. A further addition to this model could be the inclusion of an LED light that is dynamo technology-powered by the up and down motion of the person while jogging or moving in other ways. This is achieved by using magnetic induction to create an electrical current that powers an LED light. Alternatively, a small battery can power an LED Light. These elements can be integrated internally into the decorative cover, or attached to the decorative cover.

What I claim is:

1. A device for decoratively enhancing a cylindrical body comprising
an attachment portion and a decorative portion,
where the attachment portion has a top member and two side members, where the two side members are each attached to a side of the top member, where the top member and two side members form an inner surface and an outer surface, where the inner surface of the attachment portion surrounds an inner cavity, where the inner cavity has an inner diameter, where the attachment portion is capable of gripping a roughly cylindrical body, where the roughly cylindrical body has an outer diameter, where the roughly cylindrical body fits into the inner cavity of the attachment portion when the attachment portion grips the roughly cylindrical body, and
where the decorative portion comprises a form of decoration.

2. The device of claim 1, where at least part of the top member is flat.

3. The device of claim 1, where at least part of the top member is pointed.

4. The device of claim 1, where at least part of the top member is round.

5. The device of claim 1, where the decorative portion is one or more decorations proximate to the top member.

6. The device of claim 1, where the decorative portion is one or more decorations proximate to at least one of the two side members.

7. The device of claim 1, where the decorative portion is etched or engraved into the top member.

8. The device of claim 1, where the top member is approximately 20 mm long, where the portions of the side members furthest away from the top member are approximately 14 mm long, and where the width of each side member is approximately 4 mm.

9. The device of claim 1, where the roughly cylindrical body is the stem of an earbud.

10. The device of claim 9, where an end of the top member is faceted such that the end is of a shape and angle suitable for mating with the shape and angle of a point of junction between a stem and a speaker section of an earbud.

11. The device of claim 9, where the device covers the stem but not the speaker section of an earbud.

12. The device of claim 9, where the device covers both the stem and the speaker section of an earbud.

13. The device of claim 1, where the device further comprises a battery and a light emitting diode, where the battery is electrically connected to the light emitting diode such that the battery can power the light emitting diode causing it to emit light.

14. The device of claim 1, where the inner diameter of the inner cavity of the attachment portion is less than the diameter of the roughly cylindrical body over which the invention is intended to be attached.

15. A device for decoratively enhancing an earbud comprising:
an attachment portion and a decorative portion,
where the attachment portion comprises a roughly cylindrical gripping body with an outer surface and a hollow, inner cavity, where the gripping body has a top section, two side sections, and an approximately 90 degree open section at its bottom in between the two bottom sections, where the roughly cylindrical body is the stem of an earbud, and
where the decorative portion is arrayed upon at least some of the outer surface of the attachment portion, and where the decorative portion comprises a form of decoration.

16. The device of claim 15, where the top member is approximately 20 mm long, where the portions of the side members furthest away from the top member are approximately 14 mm long, and where the width of each side member is approximately 4 mm.

17. The device of claim 15, where an end of the top member is faceted such that the end is of a shape and angle suitable for mating with the shape and angle of a point of junction between a stem and a speaker section of an earbud.

18. The device of claim 15, where the device covers both the stem and the speaker section of an earbud.

19. The device of claim 15, where the inner diameter of the inner cavity of the attachment portion is less than the diameter of the cylinder over which the invention is intended to be attached.

20. A device for decoratively enhancing an earbud consisting of:
an attachment portion and a decorative portion,
where the attachment portion has a top member and two side members, where the two side members are each attached to a side of the top member, where the top member and two side members form an inner surface and an outer surface, where the inner surface of the attachment portion surrounds an inner cavity, where the inner cavity has an inner diameter, where the attachment portion is capable of gripping a roughly cylindrical body, where the roughly cylindrical body has an outer diameter, where the roughly cylindrical body fits into the inner cavity of the attachment portion when the attachment portion grips the roughly cylindrical body, where the roughly cylindrical body is the stem of an earbud, and
where the decorative portion comprises a form of decoration.
